(19) United States
(12) Patent Application Publication
(10) Pub. No.: US 2004/0181432 A1
(43) Pub. Date: Sep. 16, 2004

(54) Health care system

(76) Inventors: Rie Senba, Kanagawa (JP); Masakazu Asano, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/744,086

(22) Filed: Dec. 24, 2003

(30) Foreign Application Priority Data
Dec. 27, 2002 (JP) 2002-379619

(51) Int. Cl. G06F 17/60

(52) U.S. Cl. 705/2

(57) ABSTRACT

A health care system includes a management server to which a user of a diabetic patient or the like accesses via the internet from a user terminal such as a personal computer and so on. The management server provides to the user terminal interview checklists of four categories including emotion, motivation, depression and stress in repose to the access. The user performs an input of answers on the interview checklist according to a conducting procedure. The management server processes the input of the answers and stores a processing result in a database. Accordingly, the user can know an evaluation (interview result) determined by the management server by accessing the database. It is noted that in the management server, interviews are performed at appropriate timings according to priorities of respective categories of the interview lists so as to prevent the interview lists of all the categories from being performed on the same day.

### BACKGROUND OF THE INVENTION

1. Field of the Invention

The present invention relates to a health care system which interviews a user of a diabetic patient or the like and maintains and improves a user's desire of improvement by a result of the interviews.

2. Description of the Prior Art

Conventionally, a diabetic patient or the like measures vital data such as a blood pressure, a blood sugar level and etc. at home and transmits measured data to a management server via the internet from a personal computer and so on so as to store the same while a doctor, a dietician and etc. access the server from specialist terminals so as to read the measured data of the patient on a day except for a regular consultation day and point-out a change of individual data between the day and yesterday, for example. Such an at-home health care system has a possibility of partly taking charge of metal health care.

Data required for the mental health care is stored in the server not as the measured data such as the vital data of the patient but as score point (numerical) data of a result of interviews. An example of this kind of art is disclosed in a Japanese Patent Laying-open No. 2000-37354 [A61B5/00 A63B24/00, 69/00 G06F19/00] laid-open on Feb. 8, 2000.

In the prior art, when a plurality of interview data described in a mark sheet or mark card to be transmitted from a patient are input to a data processing portion, an index indicative of a degree of establishment of improvement of a lifestyle of a diabetic patient or the like is calculated on the basis of a result of interviews so as to require the patient of improving his mind by displaying or recording such an index.

However, there occur problems that since a plurality of interviews are conducted in such the system without priority, this increases a burden on the patient, and a mental attitude that the patient himself enthusiastically performs with a will cannot be found.

Therefore, recently, interviews with a plurality of categories based on a psychological aspect of the patient such as feelings, emotion, depression or the like are attempt to be conducted; however, conducting the interviews of all the categories on the same day not only increases a burden on the patient is but also inconvenient for the patient.

### SUMMARY OF THE INVENTION

Therefore, it is a primary object of the present invention to provide a novel health care system.

Another object of the present invention is to provide a health care system capable of performing interviews at appropriate timings depending upon categories.

A health care system according to the present invention includes a management server and a user terminal connected to each other via a communication network, presents interview lists of a plurality of categories different from each other from the management server to the user terminal and allows a user to perform an answering input to each of the interview lists. The categories include a first category to be interviewed every day, a second category and third category each to be periodically interviewed every two and more days. The health care system includes an applicable date determiner for determining whether the applicable date when an interview of an applicable category is to be executed or not by taking precedence execution of the second category interview over execution of the third category interview, and a first interview conductor for conducting the interview of a category determined to be the applicable date by the applicable date determiner.

In the health care system of the present invention, when the user such as a diabetic patient or the like accesses the management server via the internet by use of the user terminal, the interview lists of the plurality of categories different from each other are presented to the user terminal from the management server. The user confirms whether or not the applicable date or not with respect to the applicable date of each of the interview lists presented depending upon the first category to be interviewed every day, the second category and the third category both having to be conducted in an order of priority and, if the applicable date, enters the answers with respect to the interviews according to the procedure so that a interview result (processing result) is accumulated in a database connected to the management server through a predetermined process of the management server. Then, the user accesses the database so as to appropriately read the processing result of each of the interviews in the management server. Furthermore, the user can view by use of the user terminal a short report periodically created based on a past interview history accumulated in the management server.

According to the present invention, by preparing interviews of the plurality of categories different from each other and automatically conducting them at predetermined timings, it is possible to conduct the second category and the third category in an order of priority, and whereby, it is possible to decrease a burden on the user.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematically configuration block diagram showing one embodiment of a health care system according to the present invention;

FIG. 2 is a part of a flowchart showing an operation of the health care system shown in FIG. 1;

FIG. 3 is another part of the flowchart showing the operation of the health care system shown in FIG. 1;

FIG. 4 is the other part of the flowchart showing the operation of the health care system shown in FIG. 1;

FIG. 5 shows one example of a layout of a mental interview menu screen utilized in the health care system of the present invention;

FIG. 6 shows one example of a layout of a questions presenting screen for an emotion check which is a basic mental interview on the mental interview menu screen shown in FIG. 5;

FIG. 7 shows one example of a determination screen for emotion check displayed in a case of clicking a button for determination result 1 shown in FIG. 6;

FIG. 8 shows one example of a past history for emotion check displayed in a case of clicking a button for determination result 2 shown in FIG. 6;

FIG. 9 shows one example of the questions presenting screen in a case of clicking a stress check on the mental interview menu screen shown in FIG. 5;

FIG. 10 shows one example of the questions presenting screen in a case of clicking a depression check on the mental interview menu screen shown in FIG. 5;

FIG. 11 shows one example of the questions presenting screen in a case of clicking a motivation check on the mental interview menu screen shown in FIG. 5;

FIG. 12 is one example of an imaginary screen indicative of a content of a short report;

FIG. 13 (A) and FIG. 13(B) are examples of a mental points table during the past week and a graph showing its changes; and

FIG. 14 (A) and FIG. 14 (B) are other examples of a mental points table during the past week and a graph showing its changes.

### DETAILED DESCRIPTION OF THE PREFERRED EMBODIMENTS

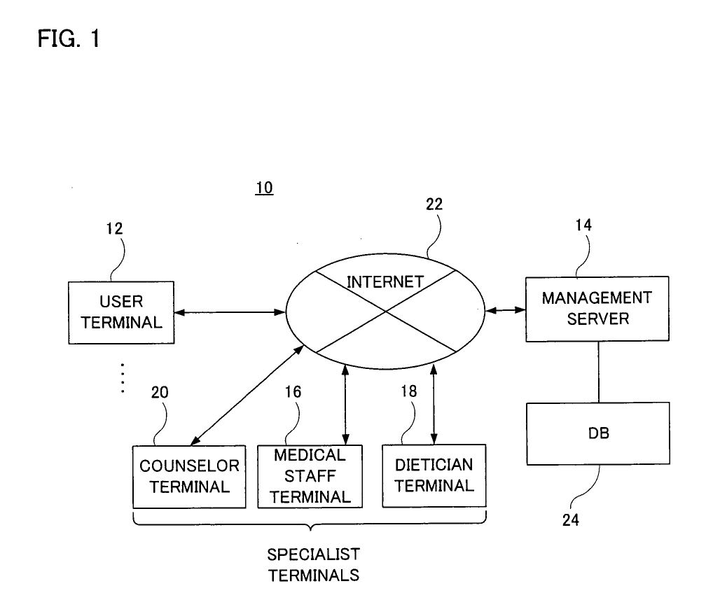

Referring to FIG. 1, a health care system 10 of one embodiment according to the present invention includes a plurality of user terminals 12, 12, . . . provided in respective homes of users such as a diabetic patient or the like, a management server 14 and specialist terminals including a medical staff terminal 16 for a doctor, a nurse and etc., a dietician terminal 18 and a counselor terminal 20 for a psychological counselor and etc.

Then, the plurality of user terminals 12, 12, . . . , the management server 14, the medical staff terminal 16, the dietician terminal 18 and the counselor terminal 20 are connected with each other via a communication network 22 including the internet.

The user terminal 12 is loaded with application software capable of displaying a screen of a browser or text, and equipment connectable with a wide-area network 22 such as the internet 22, a personal computer, a portable communication terminal or the like. Furthermore, the management server 14 is a computer connected with each of the user terminals 12 via the network and is preferably a server computer, a workstation or the like having a processing ability higher than that of a personal computer.

Furthermore, each of the medical staff terminals 16, the dietician terminal 18 and the counselor terminal 20 is constructed by a personal computer or the like similarly to the user terminal 12.

It is noted that the management server 14 is provided with a database (DB) 24 storing or saving an identification number and a password for specifying a user including a patient registered in advance as a member, personal data, various kinds of data required for processing, mental interview check lists (described later) and etc.

Next, a description is made on an outline of an operation of the health care system shown in FIG. 1.

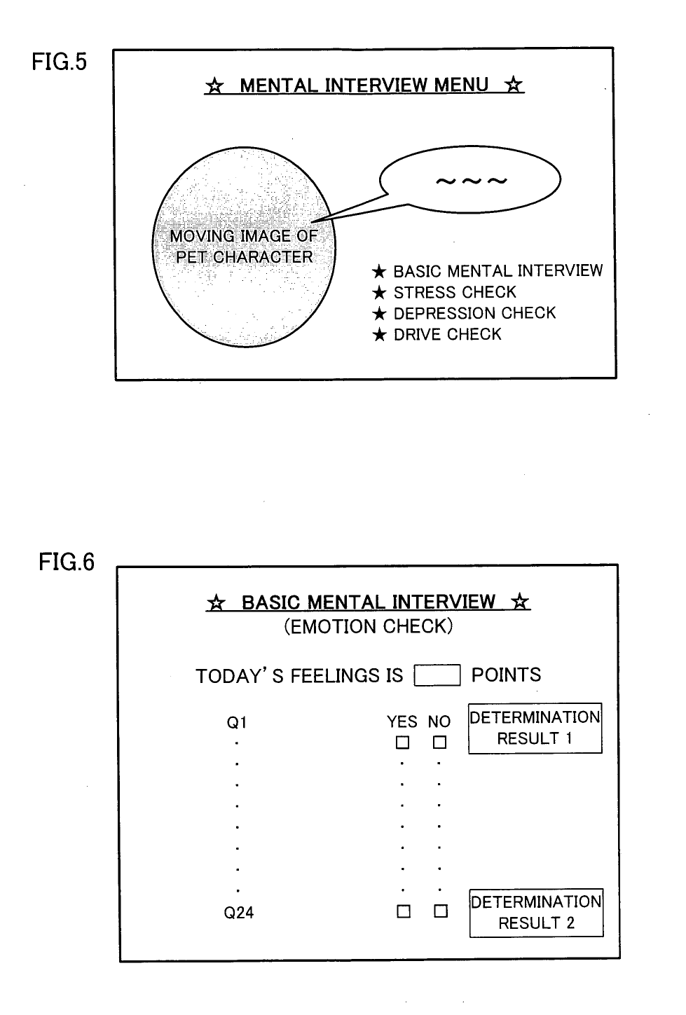

First, when the user such as a diabetic patient or the like accesses the management server 14 from the user terminal 12 so as to open an internet website, the user terminal 12 is displayed with a mental interview menu screen of a plurality of categories (e.g., four) different from each other as shown in FIG. 5.

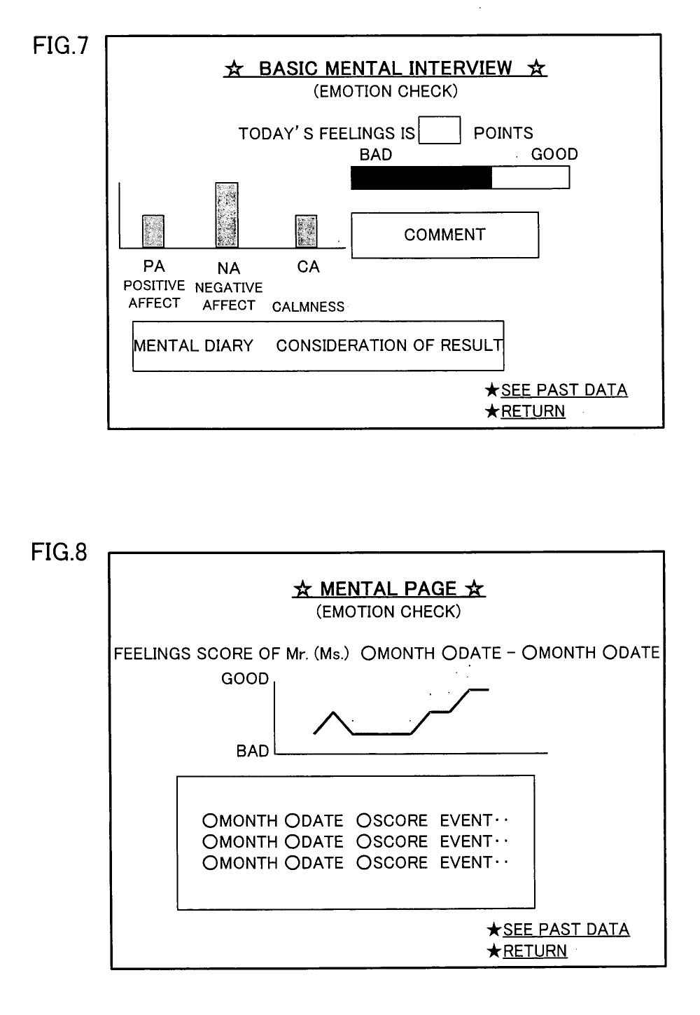

Next, when the user clicks an item of a basic metal interview on the mental interview menu, a questions presenting screen for feelings or emotion check shown in FIG. 6 is displayed. The user, while viewing the questions presenting screen, enters his or her today's feelings by a score point and checks each questionnaires and entries an answer (YES or NO) to the question. Then, when the user clicks a button for determination result 1, a determination screen for emotion check shown in FIG. 7 is presented by a bar graph. It is noted that although a choice between YES and NO is illustrated as an answering method in this embodiment, a choice among YES, NO and NEITHER can be taken as the answering method in another embodiment. In such the choice between three, “YES”, “NEITHER” and “NO” are summed-up as two (2) points, one (1) point and zero (0) point, respectively, and whereby, a graphical representation described above can be performed by a total score point.

The determination screen is displayed with a comment based on a determination result, and the user can enter his or her feelings by viewing the determination result. Furthermore, when the user clicks a button for determination result 2 in FIG. 6, a one-sight screen of a past history shown in FIG. 8 is displayed. The user can look back one's state of mind by viewing the graphical representation and etc. on the sight screen.

A measuring result such as a content of the determination result (measuring result) shown in FIG. 7 and a one-sight content of the past history shown in FIG. 8 are accumulatively saved in the database 24 connected to the management server 14. Furthermore, the determination (measuring) result is transmitted from the management server 14 to the medical staff terminal 16 for doctor and etc., the dietician terminal 18 for dietician and the counselor terminal 20 for psychological counselor and etc. so as to be read by each of the specialist terminals. It is noted that the transmission of the measuring (determination) result to each of the terminals 16, 18 and 20 may be performed on condition that the management server 14 accepts a request for approval from the user terminal 12.

Then, a specialist of the medical staff and etc. deliberately analyzes the measuring result and additionally enters necessary comments. Analysis information with additional information is transmitted via the management server 14 from the medical staff terminal 16, the dietician terminal 18 and the counselor terminal 20 to the user terminal 12 from which the user reads the analysis information so as to know a detailed state of mental health. In this case, the analysis information including the additional information is also accumulated and stored in the database 24 of the management server 14.

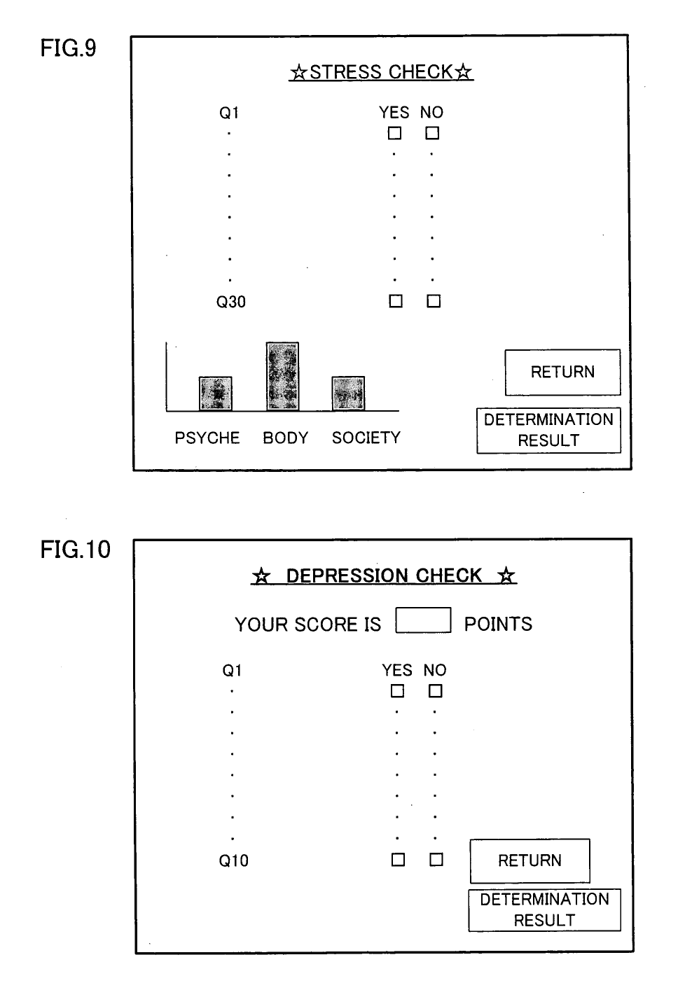

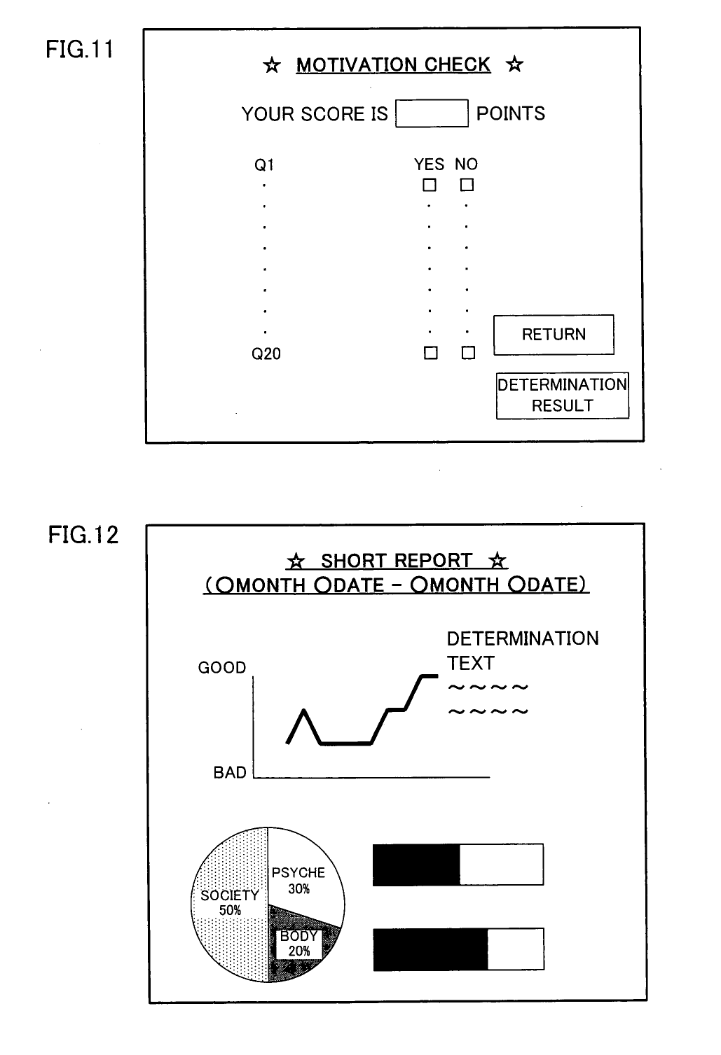

Furthermore, by clicking each of the interview lists including a stress check, a depression check and a motivation check on the mental interview menu screen in FIG. 5, each of questions presenting screens shown in FIG. 9, FIG. 10 and FIG. 11 is presented to the user terminal 12. The user inputs an answer with respect to each of questionnaires entries presented in each of the screens, and this makes it possible to measure the state of the mental health of the user specified by the management server 14 through necessary processes.

It is noted that in a case the management server 14 is a computer having a higher processing power, an analysis result can be processed on the basis of a large amount of mental health information and the database 24, and therefore, it is possible to rapidly transmit the accurate information to the user terminal 12.

In addition, it is appropriate that the management server 14 has a user information accumulating function for accumulating (storing or saving) the received mental health information of the user in the management server 14 for each user, and a mental health state analyzing function may analyze a state of the mental health of the user on the basis of the health information for each user accumulated in the management server 14 and the health information database. Thus, the mental health information of the user is periodically, e.g., every day, every weekend or every month-end and every month's outset accumulated in the management server 14 and can be analyzed with reference to past mental health information, whereby, it is possible to obtain a more accurate analysis result and thus prevent occurrence of a lifestyle-related disease.

Herein, a description is made on the mental interview check lists (mental interview lists) equipped in the above-described health care system 10.

An infinite number of strategies for the mental check lists for grasping a psychological health state (mental health state) and for the determination method of the answer are present but may newly be created. The health care system in the present invention takes it into account that the user being especially the diabetic disease is mainly targeted and proposes that the interview check lists formed by four different categories should be equipped.

Then, a description is made on an advantage of preparing four categories of the mental interview in following items (1) to (4).

(1) It is possible to multilaterally grasp a state of mind having various aspects of a human.

(2) By use of a result of the check lists for measuring different aspects, it is possible to work on an aspect concentrating on an especially controversial aspect of the user, and whereby, it is possible to effectively maintain the mental health.

(3) Integrating a plurality of results makes it possible to obtain an overall grasp of an individual and to output a result thereof.

(4) By changing timings of presenting batches of questions depending upon each of measuring aims, it is possible to bring about changes in an answering effort to the interview performed every day, and whereby, it is possible to continue to give a fresh impression.

Then, the batches of interviews for four categories presented in the system are as follows.

(1) A checklist for measuring a state of feelings/emotion (hereinafter, referred to as “emotion check”).

(2) A checklist for measuring a degree of stress experienced by the patient (hereinafter, referred to as “stress check”).

(3) A checklist for measuring progress of depressive tendencies (hereinafter, referred to as “depression check”).

(4) A checklist for measuring a degree of motivation of the patient playing active roles in a medical treatment (hereinafter, refereed to as “motivation check”).

Herein, a description is made on an intention of selecting the four different batches of interviews and assumed advantages as follows.

(1) Emotion (Feelings) Check: First Category Interview

It is to be expected that conducting the emotion check urges the patient to aware his emotion, representing the emotion by a language form or a numerical form recognizably resystematizes a negative emotion which is not sorted out, and increase of the mental health and improvement of self-control thus generated realize healing. Furthermore, such the advantages are supported by information or knowledge of psychiatry and clinical psychology that awareness to daily emotions contributes to maintain and increase the mental health.

(2) Stress Check: Fourth Category Interview

It is to be expected that conducting the stress check makes it easy for the patient to aware of self stress level, and to execute voluntary stress management. Furthermore, it is known that experience of the stress hinders health of a body through a nervous system, an immune system and an endocrine system and decreases an effect of medical treatment or remedy. The patient himself is voluntarily aware of the stress and early conducts the stress management, and whereby, physical health is maintained. Furthermore, it is to be expected that by allowing a medical staff and a dietician to utilize a result of the check, communication becomes easy, and more effective treatment can be performed.

(3) Depression Check: Third Category Interview

It is to be expected that conducting the depression check early detects development of depression being one of complications of diabetes. Furthermore, a state of depression deprives the patient of motivation and leads to backset of self-care conduct including dosing and exercises; however, early detection of the state of the depression and voluntary treatment thereof leads to decrease of psychological anguish and continuation of the self-care conduct.

(4) Motivation Check: Second Category Interview

Conducting the motivation check is effective in early detecting a lowering of motivation for lifestyle-related diseases management, in determining when to apply a comment and content for supporting lifestyle management to the patient depending upon a condition and in determining a time to stop utilizing the system.

In a case of conducting the above-described batches of interviews including each of the first, the second, the third and the fourth categories, the mental interview menu screen shown in FIG. 5 is created and then shifted to a page inserted with the questionnaires entries in response to selection of the menu screen. All the batches of the interviews can be conducted no matter when and no matter what times the user needs. Therefore, it is necessary to prepare the menu screen as an entrance to a desired interview. The menu screen is registered and stored in the management server 14 to which the user can access from the user terminal 12 via the internet 22.

Furthermore, it is preferable that the emotion check of the first category interview which requires to be answered every day is started in conjunction with start-up of the system. In addition, other batches of interviews, i.e., the stress interview of the fourth category (conducted on every specific day of a week), the depression interview of the third category (conducted once at the end of a month) and the motivation interview of the second category (conducted once at the beginning of a month) can be started-up at timings respectively prepared, or a pet character indicates messages of encouragement to do the check, and whereby, it is possible to execute the interviews of four different categories at optimal timings and regularly.

Next, a description is made on conducting timings for conducting the mental interviews of four categories and integration of results.

The mental interviews of four categories have respective optimal conducting timings and are automatically conducted according to the respective timings.

More specifically, the interviews except for the interview for emotion check to be conducted every day are required for announcement of the conduct by the pet character and etc. on the previous day or a week ago. Furthermore, in a case a plurality of interviews have to be performed on the same day, that is, the second category interview and the third category interview are to be performed on the same day, for example, the second category interview is executed prior to the third category interview, and therefore, it may be said that one interview is selected and conducted according to an order of priority; however, in a case of desiring the other interview which is not selected, the user can select the interview from the menu screen according to an advisory message of the character and etc.

Furthermore, a short report (described later) which integrates all the measuring results is created at a predetermined timing such as every weekend. The short report includes data during the week, a total score point calculated for representing a state of mind of the patient and a picture of plants illustrating the total score point together with characters for healing the picture of the plants, for example.

Then, a description is made on detailed items such as questionnaires entries as to the above-described mental interview check list with four categories.

1) Emotion Check:

In performing the emotion check, newly developed batches of questions and a mental score (what number would current feelings on a scale of 1 (one) to 10 (ten), 10 being the best feelings) are supposed to be utilized with referring to the General Affect Scale (questionnaires entries of 24=Q1 to Q24 in the form of questions and answers between YES and NO). One example of the questions presenting screen for emotion check is shown in FIG. 6 described before.

A description is made on instruction and items of the General Affect Scale.

The instruction is questions for measuring a state of total feelings. First, current feelings are entered by a score point, 10 being a perfect score for the best feelings. Next, all the appropriate answers applicable to the current feelings are checked in “YES and NO” columns.

Conventionally, the batches of questions are described by an epithet in the General Affect Scale; however, such the batches of questions represented by the epithet give unnatural impression to the user who is unaccustomed to a psychological questionnaire survey and are difficult to be answered. Therefore, in this system, a query form is improved from the epithet to the text form on the basis of the General Affect Scale.

In detailed contents of the questions, as a positive affect (PA) group, Q1 is, for example, “I am cheerful feelings now” . . . . As a negative affect (NA) group, Q9 is, for example, “I am in a flutter now” . . . . Furthermore, as a calmness (CA) group, Q17 is, for example, “I am calm feelings” . . . .

Furthermore, as a marking method of the emotion check, the number of questionnaires entries checked as “YES” is counted and scored every PA group, NA group and CA group which are subordinate scales to the emotion check.

In addition, each of the subordinate scales is constructed by eight (8) items, and therefore, the score point of each of the PA group, the NA group and the CA group is distributed in the range 0 (zero) point to 8 (eight) points. Determination text to be displayed on a column for comment is controlled on the basis of the values of the respective scores and balance of the respective scores of the PA group, the NA group and the CA group.

2) Stress Check:

The check list is for measuring a symptom of stress from three aspects of “mentality (psyche)”, “physique (body)” and “society (socialization)” on the basis of a concept of health of the World Health Organization and in view of health psychology. It is noted that the number of questionnaires entries for the stress check is 30 (=Q1 to Q30).

Showing one example of contents of the detailed questions, Q1 is that the body is get tired of easily, . . . Q11 is that there are a number of little irritating thing, . . . Q21 is that there increases mistakes in business or in study, and so on.

3) Depression Check:

This depression check is available for early detecting development of depression which is one of complications of diabetes and for early detecting lowering of motivation for utilizing the system due to the depression tendencies. It is noted that the number of questionnaires entries is ten (=Q1 to Q10) in the system.

Showing detailed contents of the questions, Q1 is that you feel low every day, . . . Q10 is that you feel suffocated and chocked, and so on.

4) Motivation Check:

By providing the checklist of the motivation in the system, it is possible to early detect lowering of motivation for the lifestyle management, and it is possible to take measures including applying a supportive comment and contents thereof to the patient depending upon a state and etc. Furthermore, it would be best for the patient to obtain comments from a doctor and a dietician. It is noted that the number of questionnaires entries for the stress check is twenty (=Q1 to Q20).

Showing detailed contents of the questions, Q1 is that you don't want to give up early, . . . Q11 is that you seem to spend freely and easily, . . . Q20 is that you intend to do your best to the last even when doing a boring thing, and so on.

5) Short Report:

In order to heighten awareness to a state of mind of himself to be lead to healing, the system creates a short report of approximately one page which summarizes the mental interview result (past history) during the past week once a week such as a weekend. The report is basically read on the web page; however, a created sheet may alternatively be sent by mail.

Contents of the short report are described in (1) to (5).

(1) In a graph of a mental score of one week and its determination text, changes and gradients of a graph such as sharp or moderate changes, i.e., tendency of high spirits or low spirits toward the weekend are simply described. It is noted that a determination method of changes of the graph is described later.

(2) The result of the stress check represents a balance of the scores of the “mentality (psyche)”, the “physique (body)” and the “society (socialization)” by a circle graph and, at the same time, describes an answering day.

(3) The result of the depression check and the motivation check are represented by a bar graph, for example and, at the same time, describes an answering day.

(4) The total score point is represented by calculating changes of the mental score, a stress score, a depression score and a motivation score. The calculating method is described later.

(5) An image of healing is, as a reflection of a state of mind of the user according to the above-described total score point, represented by a flower or plants (e.g., a picture of a flower which is upwardly in bloom or hangs down its head) on which the character performs a healing action. The healing action is to touch the flower, give water, spread fertilizer, tie a ribbon, play a music box, take a picture, talk, and so on. The image is represented by a moving image on the web page and by a four-frame cartoon as a paper medium.

Then, a determination method of changes of the graph of the mental score point is described.

The number of the mental scores graphically represented in the short report is seven (one week). By rendering Sunday of a beginning day as an initial value of 0, a comparison between a score of a day and a score of a previous day is represented by an increase, a decrease or a constant which are respectively represented by markers of +, − and 0.

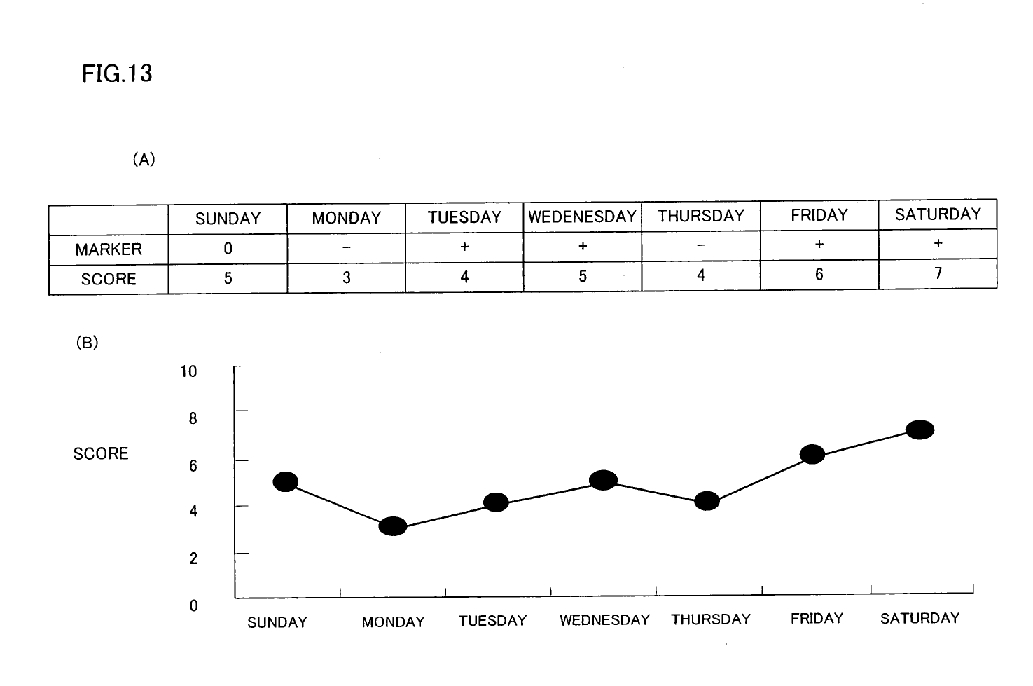

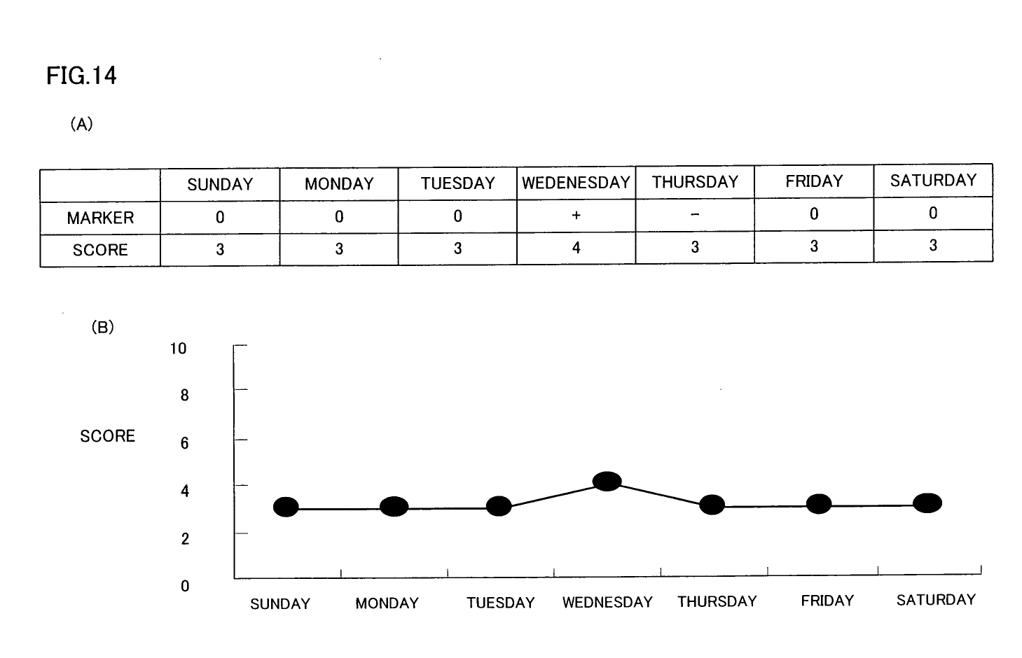

One example thereof is shown by tables and graphs in FIG. 13 (A) and FIG. 13 (B) and FIG. 14 (A) and FIG. 14 (B), respectively. With referring to FIG. 13 and FIG. 14, if each of the number of the markers + and the number of the markers − is more than the number of the markers 0, it is determined to be varied while if the number of the markers 0 is more, it is determined to be stable.

Furthermore, as another determination method, a representative value (a median of the scores is appropriate) of the first half of the week (Monday to Wednesday) is compared with a representative value of the last half of the week (Thursday and Friday), and if the value of the last half of the week is larger, it is determined to be “rising” while if the value of the first half of the week is larger, it is determined to be “falling”. In addition, if the same value, it is determined to be “stabilizing”.

Furthermore, a comparison of the markers between Friday and Saturday is performed, and if the marker of Saturday is +, it is determined to be “rising”, if it is −, it is determined to be “falling”, and if it is 0, it is determined to be “stabilizing”.

In addition, a maximum value and a minimum value are compared with each other, and if a difference thereof is more than a reference value (e.g., 4 points), it is determined to be “varied sharply”, and if the difference is equal to or lower than the reference value (e.g., 2 points), it is determined to be “stabilizing”.

Then, a calculating method of the total score point is performed by use of following categories. Three categories of “increasing”, “falling” and “stabilizing” assigned in the changes of the above-described mental scores, five categories of normality/diversion/rest/healing/consultation of the stress check score level, three categories of slight/moderate/severe of the depression check score level and two categories (large level (3) (4) and small level (1) (2)) of the motivation check score level are utilized.

In addition, if the above-described data cannot be obtained due to deficit values, for convenience, such the deficit values may be replaced with the “stabilizing”, “normality”, “moderate” or “small level”.

A combination of the above-described categories has, by simple arithmetic, 90 (=3×5×3×2) possible cases. The healing actions of the pet character corresponding to a plurality of cases make wide variations; however, if it is difficult, 15 (=3×5) cases combining only the mental score category and the stress check or 15 (=5×3) cases combining the stress score and the depression score may be possible.

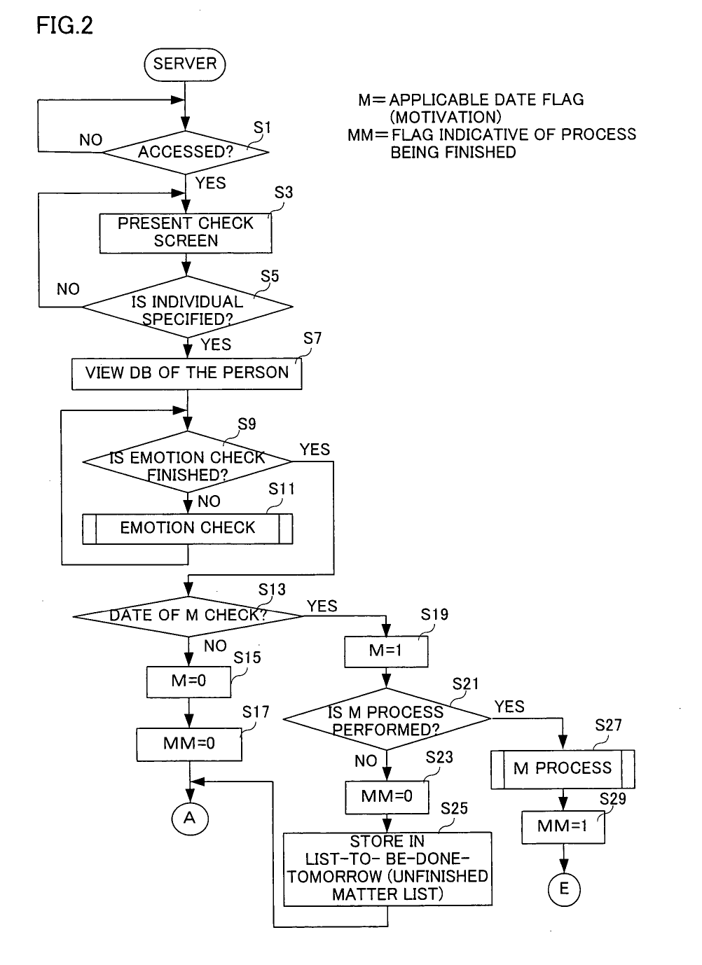

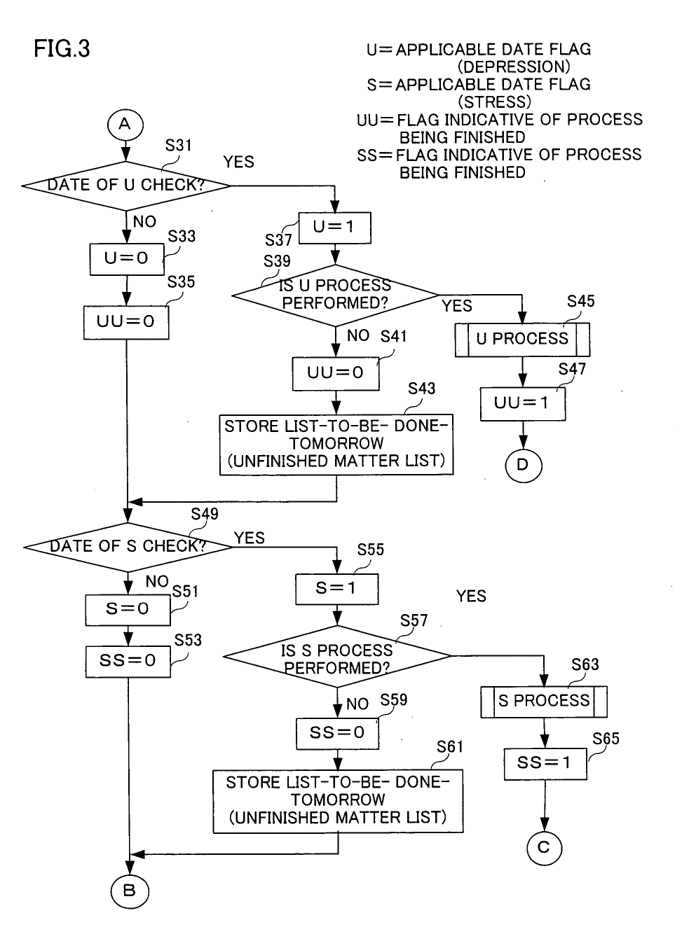

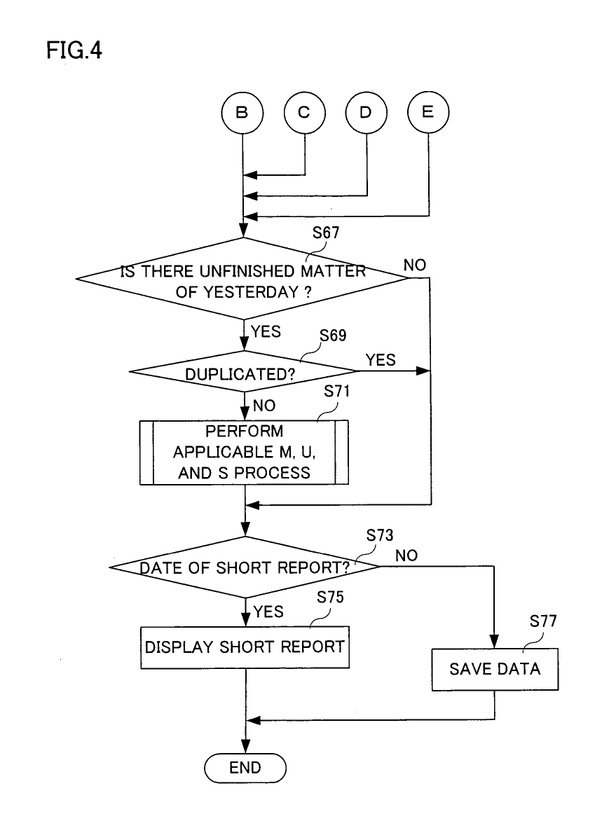

Herein, conducting timings and a processing operation of the mental interviews (respective checks for emotion, motivation, depression and stress) of different four categories are described with reference to a series of flowcharts shown in FIG. 2 to FIG. 4.

First, it is determined whether or not access is present from the user terminal 12 to the management server 14 via the internet 22 by the user such as a patient or the like in a step S1. If “NO”, that is, if there is no access from the user, the process is returned while if “YES”, that is, if there is access from the user, the process proceeds to a following step S3 so as to present the check screen to the user terminal 12 from the management server 14. Then, it is determined whether or not the management server 14 specifies an individual in response to an input of an identification number and a password on the check screen by the user in a step S5. If “NO”, i.e., “no input”, the process returns to the step S3 so as to perform an input. Then, if “YES”, the process proceeds to a step S7 so as to view a database of a person (user) specified in the management server 14.

Then, it is determined whether or not the emotion check of the first category interview to be conducted every day has been finished by viewing the database of the specified user in a step S9, and if “NO”, the questions presenting screen (FIG. 6) based on the emotion check list (the number of questions=Q1 to Q24) is presented to the user terminal 12 so as to be subjected to a predetermined process relating to emotions in a step S11, and then, the process is returned to the step S9. If “YES” is determined in the step S9, that is, if the emotion check has been finished, the process proceeds to a step S13. In the step S13, it is determined whether an applicable date of the motivation check or not by an applicable date determination function of the management server 14, and if “NO”, that is, if not the applicable date, a flag M of the applicable date is set to “0” (turned off) in a step S15 and then, the process proceeds to a step S17 so as to set a flag MM of completion of the process to “0”. Then, the process proceeds to a step S31.

On the other hand, if “YES” in the step S13, that is, if the applicable date of the motivation check, the flag M of the applicable date is set to “1” (turned on) in a step S19, and the process further proceeds to a step S21 so as to determine whether or not a motivation process of the second category interview is performed. If “NO”, the flag MM of the completion of the process is set to “0” indicative of the process not being performed in a step S23, and the process of the interview is stored in a list-to-be-processed-tomorrow (unfinished matter list) in a step S25, and then, the process proceeds to the following step S31. If “YES” in the step S21, the questions presenting screen (FIG. 11) based on the motivation checklist (Q1 to Q20) is presented to the user terminal 12 so as to be subjected to a motivation process by the interview conducting function of the management server 14 in a predetermined procedure in a step S27. The flag MM of the completion of the process is set to “1” indicative of the process being performed in a step S29, and then, the process proceeds to a following step S77.

It is determined whether the applicable date when the depression check of the third category interview is performed or not by the applicable date determining function in the step S31. If “NO”, that is, if not the applicable date of the depression check, a flag U of the applicable date is set to “0” indicative of not being the applicable date in a step S33, and then, the process proceeds to a step S35 so as to set a flag UU of the completion of the process to “0” indicative of the process not being performed. Then, the process proceeds to a step S49.

On the other hand, if “YES” in the step S31, that is, if the applicable date of the depression check, the flag U of the applicable date is set to “1” in a step S37. Furthermore, it is determined whether or not a depression process is performed in a step S39, and if “NO”, that is, if the process is not performed, the flag UU of the completion of the process is set to “0” indicative of the process not being performed in a step S41, and then, the process proceeds to a step S43 so as to store “the interview of the depression process” in the list-to-be-processed-tomorrow (unfinished matter list). Then, the process proceeds to the following step S49.

If “YES” in the step S39, that is, the depression process is performed, the questions presenting screen (FIG. 10) based on the depression checklist (Q1 to Q10) is presented to the user terminal 12 so as to be subjected to a depression interview process according to the conducting procedure by the interview conducting function of the management server 14 in a step S45. The flag UU of the completion of the process is set to “1” indicative of the “the depression interview process” being performed in a step S47, and then, the process proceeds to a following step S67.

Then, it is determined whether the applicable date when the stress check of the fourth category interview is performed or not by the applicable date determining function in a step S49. If “NO”, that is, not the applicable date of the stress interview, a flag S of the applicable date is set to “0” indicative of not being the applicable date in a step S51, a flag SS of the completion of the process is set to “0” indicative of the process not being performed in a step S53 and then, the process proceeds to the step S67. On the other hand, if “YES” in the step S49, that is, the applicable date of the stress check, the flag S indicative of the applicable date is set to “1”. Then, it is determined whether or not a stress process is performed in a step S57, and if “NO”, that is, a stress interview is not performed, the flag SS of completion of the process is set to “0” indicative of the interview not being performed in a step S59, “the stress interview” is further stored in the list-to-be-processed-tomorrow (unfinished matter list) in a step S61 and then, the process proceeds to the step S67.

If “YES” in the step S57, that is, the stress interview is performed, the questions presenting screen (FIG. 9) based on the stress check list (Q1 to Q30) is presented on the user terminal 12 so as to be subjected to the stress interview process according to the conducting procedure by the interview conducting function of the management server 14 in a step S63. The flag SS of the completion of the process is set to “1” indicative of the interview being performed in a step S65, and then, the process proceeds to the step S67.

Now, it is determined whether or not a process-to-be-done-yesterday (unfinished matter) is present in the step S67. If “YES in the step S67, it is further determined whether or not the process-to-be-done-yesterday identifies with a process-to-be-done-today in a step S69. If “NO” in the step S69, a message including a name of the interview to be checked, e.g., “X X was not done yesterday” is displayed in a step S71, and whether or not the applied interview is to be processed is confirmed by the user in a step S73. If “YES”, the interview process applicable to any one of the motivation, the depression and the stress is performed in a step S75, and then, the process proceeds to a step S77.

On the other hand, if “NO” in the step S67, if “YES” in the step S69 and if “NO” in the step S73, the process proceeds to the step S77 in either case.

Then, it is determined whether the date of each of the second category interview, the third category interview and the fourth category interview or not in the steps S13, S31 and S49, respectively, and if “NO” in respective cases, it is determined whether or not the unfinished matter is present in the step S67. If “YES” in the step S67, the interview process of the applicable category is performed in the following step S75.

It is determined whether or not the date of the short report in the step S77, and if “YES, that is, if the applicable date, the short report (see FIG. 12) created by a short report creating function of the management server 14 based on the past history data accumulated in the database 24 is displayed on the user terminal 12 in a step S79, and then, a series of processes is ended. Furthermore, if “NO” in the step S77, the interview process data is stored in the management server 14 in a step S81 and then, the process is ended.

In the series of processes described above, the motivation check of the second category interview is conducted prior to the depression check of the third category interview. Furthermore, the depression check of the third category is conducted prior to the stress check of the fourth category.

It is noted that displaying the short report in the step S79 can be transmitted to the specialist terminals except for the user terminal 12, such as the medical staff terminal 16, the dietician terminal 18 or the counselor terminal 20 via the management server 14 in compliance with wishes. In this case, by viewing the contents of the short report displayed on the specialist terminal, the specialist can input a required direction and advice so as to send them to the user terminal via the management server. Furthermore, a measuring result (determination result) every interview check (emotion check, motivation check, depression check, and stress check) may be transmitted to the specialist terminals so as to be directed and advised by the specialist every check.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A health care system which includes a management server and a user terminal connected to each other via a communication network, presents interview lists of a plurality of categories different from each other from said management server to said user terminal, and allows an user to perform an answering input to each of said interview lists, wherein
said categories includes a first category to be interviewed every day, a second category and a third category each to be periodically interviewed every two days and more, said system comprising:
an applicable date determiner for determining whether an applicable date when an interview of an applicable category is to be executed or not by taking precedence execution of said second category interview over execution of said third category interview; and
a first interview conductor for conducting an interview of a category determined to be an applicable date by said applicable date determiner.

2. A health care system according to claim 1, further comprising an unfinished matter determiner for determining whether or not there is an unfinished matter when neither of said second category interview nor said third category interview is performed, and a second interview conductor for conducting an interview of an applicable category when it is determined that the unfinished matter is present by said unfinished thing determiner.

3. A health care system according to claim 1 or 2, further comprising a short report creator for creating a short report on the basis of a past interview history.
